(19) United States
(12) Patent Application Publication
(10) Pub. No.: US 2012/0224081 A1
(43) Pub. Date: Sep. 6, 2012

(54) CAMERA DEVICE AND METHOD FOR AUTOMATIC RED-EYE AVOIDANCE OF DIGITAL IMAGES

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/301,798

(22) Filed: Nov. 22, 2011

(30) Foreign Application Priority Data
Mar. 1, 2011 (TW) 100106577

(51) Int. Cl. H04N 9/73

(52) U.S. Cl. 348/223.1; 348/E09.051

(57) ABSTRACT

In a method for automatic red-eye avoidance of digital images captured from a person using a camera device, the camera device includes a camera lens and a red-eye flash light. The camera lens captures a digital image of the person, and a face area is detected from the digital image according to a face feature value. An eyes area is detected from the face area according to an eyes feature value, and two eyeball positions are detected from the eyes area according to an eyeball feature value. The method analyzes color of each eyeball positions, and determines whether one of the eyeballs of the person is red according to the analysis result. The method invokes a red-eye flash mode of the red-eye flash light if one of the eyeballs is red, and controls the camera lens to capture a non-redeye image of the person under the red-eye flash mode.

### BACKGROUND

1. Technical Field

The embodiments of the present disclosure relate to image capturing devices and methods, and more particularly to a camera device and method for automatic red-eye avoidance of digital images captured from a person.

2. Description of Related Art

People use camera devices to take digital images of one or more subjects. Red-eye, the appearance of an unnatural reddish coloration of the pupils of a person appearing in a digital image, is a frequently occurring problem in flash photography. Red-eye is caused by light from the flash reflecting off blood vessels in the person's retina and returning to a camera device. Therefore, it is desirable to have a red-eye correction method in the camera device for automatic red-eye detection and correction to help alleviate the red-eye occurrences, so as to improve the image quality of the digital images.

### BRIEF DESCRIPTION OF THE DRAWINGS

FIG. 1 is a block diagram of one embodiment of a camera device including a red-eye avoidance system.

FIG. 2 is a flowchart of one embodiment of a method for automatic red-eye avoidance of digital images captured from a person using the camera device of FIG. 1.

FIG. 3 is a schematic diagram illustrating an example of detecting eyeballs of a person from a digital image of the person captured by the camera device.

FIG. 4 is a schematic diagram illustrating an example of analyzing the color of each of the eyeballs in the digital image of the person captured by the camera device.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

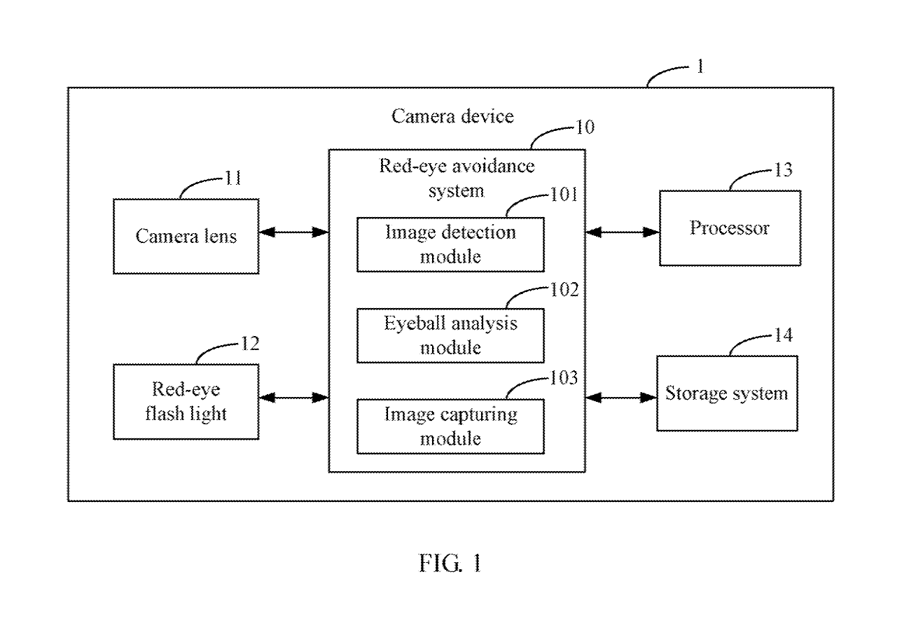

FIG. 1 is a block diagram of one embodiment of a camera device 1 including a red-eye avoidance system 10. In the embodiment, the camera device 1 may be a video camera, a digital camera, or other image capturing device having a digital camera functionality. The camera device 1 may further include a camera lens 11, a red-eye flash light 12, a storage system 13, and at least one processor 14. It is understood that FIG. 1 is only one example of a camera device 1, such a digital camera can include more or fewer components than those shown in the embodiment, or have a different configuration of the various components.

The red-eye avoidance system 10 may include a plurality of functional modules that are implemented by the camera device 1 to automatically detect and correct red-eye in a digital image captured from a person, to avoid the red-eye occurrences during capturing the digital image of the person. It is understood that red-eye is caused by light from the flash reflecting off blood vessels in the person's retina and returning to the camera lens 11.

The camera lens 11 is an optical lens which can capture digital images of a subject, such as the person of the embodiment. The red-eye flash light 12 includes a red-eye flash mode that can emit a flashlight to prevent the red-eye occurrences during capturing the digital images of the person. In one embodiment, the storage system 13 may be an internal storage system, such as a random access memory (RAM) for the temporary storage of information, and/or a read only memory (ROM) for the permanent storage of information. In some embodiments, the storage system 13 may also be an external storage system, such as an external hard disk, a storage card, or a data storage medium.

The storage system 13 stores a predefined face feature value, a predefined eyes feature value, and a predefined eyeball feature value, and a predefined eyeballs color value. In the embodiment, the face feature value may be a face similarity coefficient (e.g., a 80% similarity) that represents a part of the digital image which is the face or most closely resembles the face of the person, and the eyes feature value may be an eyes similarity coefficient (e.g., a 90% similarity) that represents a part of the digital image which does contain or is most likely to contain the eyes of the person. The eyeball feature value may be an eyeball similarity coefficient (e.g., a 95% similarity) that represents a part of the digital image which does contain or is most likely to contain the eyeballs of the person, and the eyeball color value may be a color similarity coefficient (e.g., 75% similarity) that represents the red-eye occurrences in the digital image of the person.

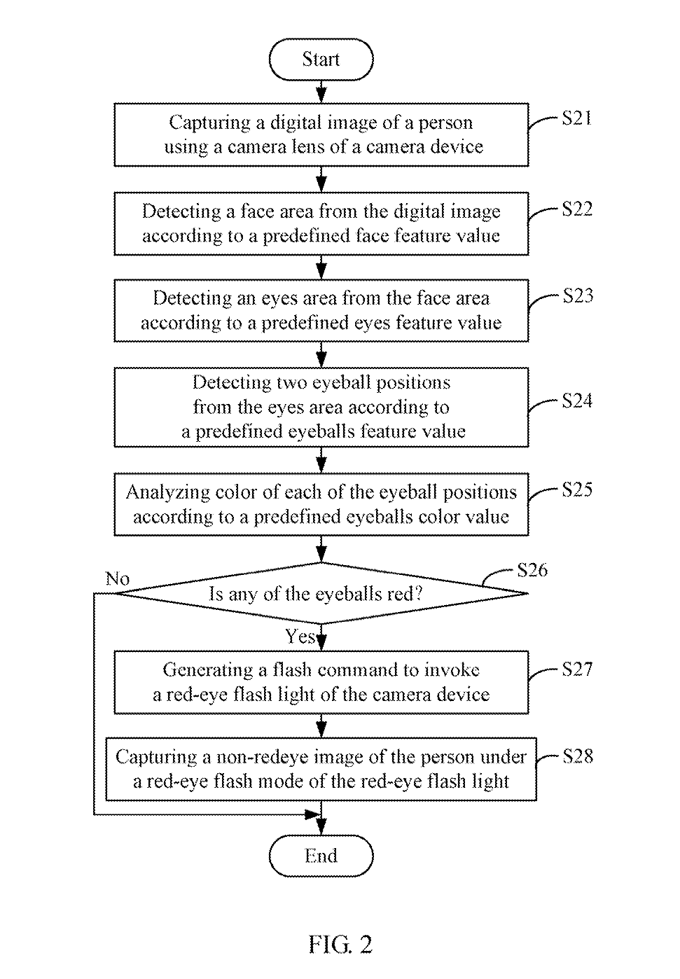

In one embodiment, the red-eye avoidance system 10 includes an image detection module 101, an eyeball analysis module 102, and an image capturing module 103. The modules 101-103 may comprise computerized instructions in the form of one or more programs that are stored in the storage system 13 and executed by the processor 14 to provide functions for implementing the modules. In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives. A detailed descriptions of each module will be given in FIG. 2 as described in the following paragraphs.

FIG. 2 is a flowchart of one embodiment of a method for automatic red-eye avoidance of digital images captured from a person using the camera device 1 of FIG. 1. In the embodiment, the method can automatically detect and correct red-eye in digital images captured from a person, to avoid the red-eye occurrences during capturing the digital images of the person. Depending on the embodiment, additional blocks may be added, others removed, and the ordering of the blocks may be changed.

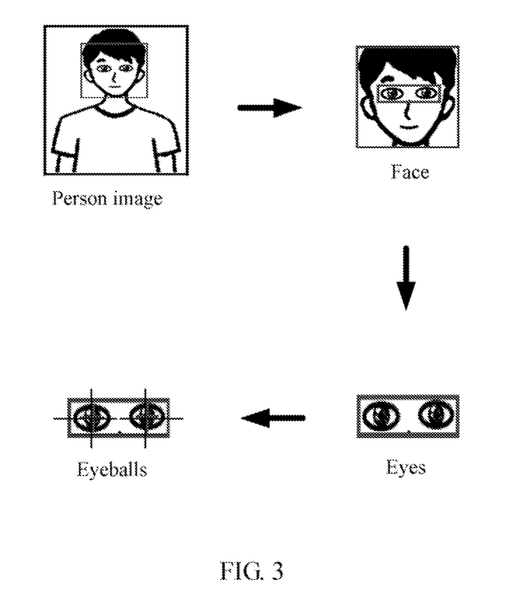

In block S21, the image detection module 101 controls the camera lens 11 to capture a digital image of the person, such as a person image as shown in FIG. 3. In one embodiment, the camera device 1 can capture a series of digital images in front of the person using the camera lens 11 at almost the same instant of time.

In block S22, the image detection module 101 detects an area of the face (hereinafter “the face area”) from the digital image according to a predefined face feature value (i.e., the 80% similarity) stored in the storage system 13. In one embodiment, if a face similarity between a part of the digital image and a predefined face sample stored in the storage system 13 is greater than the face feature value, the image detection module 101 may detect the part of the digital image as the face area, such as a face of the person as shown in FIG. 3.

In block S23, the image detection module 101 detects an area of the eyes (hereafter “the eyes area”) from the face area according to a predefined eyes feature value (i.e., the 90% similarity) stored in the storage system 13. In one embodiment, if an eyes similarity between a part of the face area and a predefined eyes sample stored in the storage system 13 is greater than the eyes feature value, the image detection module 101 may detect the part of the face area as the eyes area, such as two eyes of the person as shown in FIG. 3.

In block S24, the eyeball analysis module 102 detects a position of two eyeballs (hereafter “the eyeball position”) from the eyes area according to a predefined eyeball feature value (i.e., the 95% similarity) stored in the storage system 13. In one embodiment, if an eyeball similarity between a position of the eyes area and a predefined eyeball sample stored in the storage system 13 is greater than the eyeball feature value, the eyeball analysis module 102 may detect the position of the eyes area as an eyeball position, such as two eyeballs of the person as shown in FIG. 3.

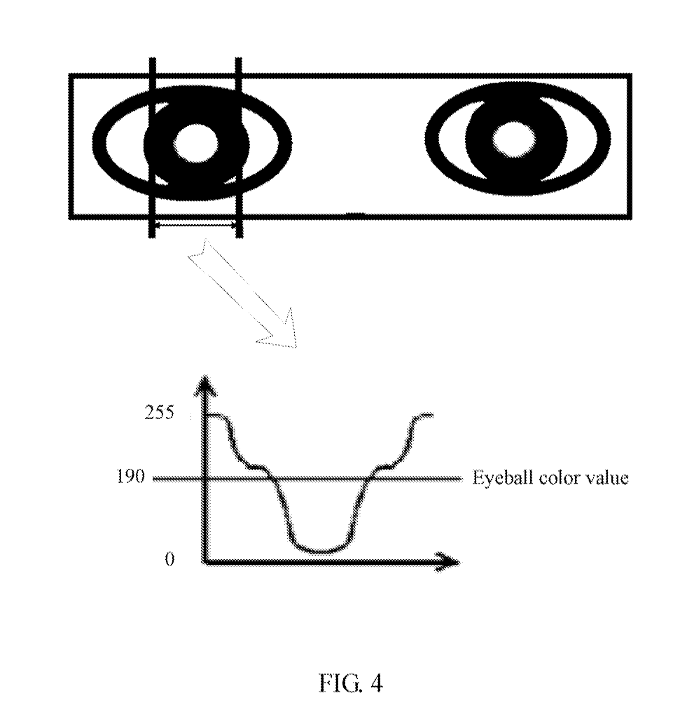

In block S25, the eyeball analysis module 102 analyzes color of each of the eyeball positions to calculate a pixel value of each of the eyeball positions. Referring to FIG. 4, the pixel value of each of the eyeball positions may be between the pixel value “0” and the pixel value “255”.

In block S26, the eyeball analysis module 102 determines whether one of the eyeballs of the person is red by comparing the pixel value of each of the eyeball positions with a predefined eyeball color value stored in the storage system 13. In one embodiment, if the pixel value of an eyeball position is greater than the eyeball color value, the eyeball analysis module 102 determines that the eyeball of the person is red. Referring to FIG. 4, the eyeball color value may be defined as 255*75%=190, where the value “255” represents a pixel value of a point in the digital image of the person, and the value “75%” represents an eyeball similarity coefficient. If one of the eyeballs of the person is red, block S27 is implemented. Otherwise, if no eyeball of the person is red, the procedure ends.

In block S27, the image capturing module 103 generates a flash command to invoke a red-eye flash mode of the red-eye flash light 12. In the embodiment, the red-eye flash light 12 can emit a flashlight to prevent the red-eye occurrences under the red-eye flash mode during capturing the digital images of the person using the camera device 1.

In block S28, the image capturing module 103 controls the camera lens 11 to capture a non-redeye image of the person under the red-eye flash mode of the red-eye flash light 12. As such, the camera device 1 can automatically detect and correct red-eye in digital images captured from the person, to avoid the red-eye occurrences during capturing the digital images of the person.

All of the processes described above may be embodied in, and fully automated via, functional code modules executed by one or more general purpose processors of the camera device 1. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A camera device, comprising:
a camera lens, a red-eye flash light, a storage system, and at least one processor; and
one or more programs stored in the storage system and executed by the at least one processor, the one or more programs comprising:
an image detection module operable to control the camera lens to capture a digital image of the person, detect a face area from the digital image according to a predefined face feature value, and detect an eyes area from the face area according to a predefined eyes feature value;
an eyeball analysis module operable to detect two eyeball positions from the eyes area according to a predefined eyeball feature value, analyze color of each of the eyeball positions to calculate a pixel value of each of the eyeball positions, and determine whether one of the eyeballs of the person is red by comparing the pixel value of each of the eyeball positions with a predefined eyeball color value; and
an image capturing module operable to generate a flash command to invoke a red-eye flash mode of the red-eye flash light if one of the eyeballs is red, and control the camera lens to capture a non-redeye image of the person under the red-eye flash mode of the red-eye flash light.

2. The camera device according to claim 1, wherein the face feature value, the eyes feature value, the eyeball feature value, and the eyeball color value are stored in the storage system.

3. The camera device according to claim 1, wherein the image detection module detects a part of the digital image as the face area if a face similarity between the part of the digital image and a predefined face sample stored in the storage system is greater than the face feature value.

4. The camera device according to claim 1, wherein the image detection module detects a part of the face area as the eyes area if an eyes similarity between the part of the face area and a predefined eyes sample stored in the storage system is greater than the eyes feature value.

5. The camera device according to claim 1, wherein the eyeball analysis module detects a position of the eyes area as an eyeball position if an eyeball similarity between the position of the eyes area and a predefined eyeball sample stored in the storage system is greater than the eyeball feature value.

6. The camera device according to claim 1, wherein the eyeball analysis module determines that an eyeball of the person is red if the pixel value of a position corresponding to the eyeball is greater than the eyeball color value.

7. A method for automatic red-eye avoidance of digital images captured from a person using a camera device, the camera device comprising a camera lens, a red-eye flash light and a storage system, the method comprising:
controlling the camera lens to capture a digital image of the person;
detecting a face area from the digital image according to a predefined face feature value;
detecting an eyes area from the face area according to a predefined eyes feature value;
detecting two eyeball positions from the eyes area according to a predefined eyeball feature value;
analyzing color of each of the eyeball positions to calculate a pixel value of each of the eyeball positions;
determining whether one of the eyeballs of the person is red by comparing the pixel value of each of the eyeball positions with a predefined eyeball color value;
generating a flash command to invoke a red-eye flash mode of the red-eye flash light if one of the eyeballs is red; and
controlling the camera lens to capture a non-redeye image of the person under the red-eye flash mode of the red-eye flash light.

8. The method according to claim 7, wherein the face feature value, the eyes feature value, the eyeball feature value and the eyeball color value are stored in the storage system.

9. The method according to claim 7, wherein the face area is detected from a part of the digital image if a face similarity between the part of the digital image and a predefined face sample stored in the storage system is greater than the face feature value.

10. The method according to claim 7, wherein the eyes area is detected from a part of the face area if an eyes similarity between the part of the face area and a predefined eyes sample stored in the storage system is greater than the eyes feature value.

11. The method according to claim 7, wherein each of the eyeball positions is detected from a position of the eyes area if an eyeball similarity between the position of the eyes area and a predefined eyeball sample stored in the storage system is greater than the eyeball feature value.

12. The method according to claim 7, wherein the eyeball of the person is determined as red if the pixel value of a position corresponding to the eyeball is greater than the eyeball color value.

13. A non-transitory storage medium having stored thereon instructions that, when executed by at least one processor of a camera device, causes the camera device to perform a method for automatic red-eye avoidance of digital images captured from a person, the camera device comprising a camera lens, a red-eye flash light and a storage system, the method comprising:
controlling the camera lens to capture a digital image of the person;
detecting a face area from the digital image according to a predefined face feature value;
detecting an eyes area from the face area according to a predefined eyes feature value;
detecting two eyeball positions from the eyes area according to a predefined eyeball feature value;
analyzing color of each of the eyeball positions to calculate a pixel value of each of the eyeball positions;
determining whether one of the eyeballs of the person is red by comparing the pixel value of each of the eyeball positions with a predefined eyeball color value;
generating a flash command to invoke a red-eye flash mode of the red-eye flash light if one of the eyeballs is red; and
controlling the camera lens to capture a non-redeye image of the person under the red-eye flash mode of the red-eye flash light.

14. The storage medium according to claim 13, wherein the face feature value, the eyes feature value, the eyeball feature value and the eyeball color value are stored in the storage system.

15. The storage medium according to claim 13, wherein the face area is detected from a part of the digital image if a face similarity between the part of the digital image and a predefined face sample stored in the storage system is greater than the face feature value.

16. The storage medium according to claim 13, wherein the eyes area is detected from a part of the face area if an eyes similarity between the part of the face area and a predefined eyes sample stored in the storage system is greater than the eyes feature value.

17. The storage medium according to claim 13, wherein each of the eyeball positions is detected from a position of the eyes area if an eyeball similarity between the position of the eyes area and a predefined eyeball sample stored in the storage system is greater than the eyeball feature value.

18. The storage medium according to claim 13, wherein the eyeball of the person is determined as red if the pixel value of a position corresponding to the eyeball is greater than the eyeball color value.

19. The storage medium according to claim 13, wherein the medium is selected from the group consisting of a hard disk drive, a compact disc, a digital video disc, and a tape drive.
